(19) United States
(12) Patent Application Publication
(10) Pub. No.: US 2024/0169551 A1
(43) Pub. Date: May 23, 2024

(54) IMAGE TRACKING METHOD AND IMAGE TRACKING SYSTEM

(71) Applicant: KINPO ELECTRONICS, INC., NEW TAIPEI CITY (TW)

(72) Inventor: Kuo-Sen TSENG, NEW TAIPEI CITY (TW)

(21) Appl. No.: 18/116,922

(22) Filed: Mar. 3, 2023

(30) Foreign Application Priority Data
Nov. 22, 2022 (CN) 202211466746.2

(51) Int. Cl. G06T 7/136; G06T 7/12; G06T 7/73; G06T 7/90

(52) U.S. Cl. CPC G06T 7/136; G06T 7/12; G06T 7/73; G06T 7/90; G06T 2207/10024; G06T 2207/20021

(57) ABSTRACT

Image tracking method and image tracking system are provided. The image tracking method includes capturing an initial image including a plurality of object-to-be-detected images. Each object-to-be-detected image includes a tracking region and a main region, and a pixel difference between the tracking region and the main region is greater than a threshold. The method includes executing an image processing on the initial image to obtain a binary image including a plurality of image object contours, computing a minimum bounding rectangle of each image object contour, and comparing the minimum bounding rectangle of each image object contour with a default rectangle to choose one minimum bounding rectangle matching the default rectangle to be a positioning region. The method includes generating an identifying box according to the positioning region and displaying the initial image tagged with the identifying box which overlays on the tracking region.

### BACKGROUND OF THE INVENTION

### Technical Field

The technical field relates to an image tracking method and an image tracking system, and more particularly, to an image tracking method and an image tracking system for identifying an object feature in an image and tagging an object based on the object feature.

### Description of Related Art

In the image tracking procedure, the tracking system analyzes the image to obtain the feature of the to-be-detected object. When the feature of the to-be-detected object cannot be analyzed from the image, the tracking system cannot track the to-be-detected object based on the feature of the to-be-detected object.

To recognize the feature of the to-be-detected object, the tracking system executes the binary processing to the object-to-be-detected image to obtain the binary image. Because the binary process can accentuate the contour of the object in the image, the tracking system can recognize the feature of the to-be-detected object. However, some types of to-be-detected objects are not suitable for the tracking procedure. Furthermore, the tracking system may be used to process different types of to-be-detected objects, and the differences include the color, the appearance, and the pixel value, etc. of the to-be-detected object, the relation among the pixel value of the candidate features, or the relation among the candidate features and the housing objects. Because of the differences, the engineer has to adjust the program and the settings for each type of to-be-detected object before the tracking system detects different types of to-be-detected objects.

Accordingly, how to correctly recognize the feature of the to-be-detected object for image tracking and how to decrease the engineer's loading for adjusting the program and the settings for each type of the to-be-detected object before the image tracking system detects the to-be-detected object of different types under the premise of remaining the consistency of the program architecture without changing the program architecture are the problems to be solved.

### SUMMARY OF THE INVENTION

The disclosure is directed to an image tracking method including capturing, by an image capturing device, an object-to-be-detected image of a to-be-detected object, wherein the to-be-detected object includes a trackable feature and the object-to-be-detected image includes a plurality of first candidate objects and a housing object with a first color, and a pixel value of the plurality of first candidate objects is different from a pixel value of the housing object; processing the object-to-be-detected image by using a gray-scale threshold to obtain a gray-scale image including a plurality of gray-scale candidate objects and a gray-scale housing object; converting the gray-scale image into a binary image by using a binary threshold, wherein the binary image includes a plurality of second candidate objects with the first color and the housing object with a second color; obtaining a plurality of minimum bounding rectangles of the plurality of second candidate objects of the binary image; choosing one of the plurality of minimum bounding rectangles to be a tagging position of the trackable feature; and displaying, on a display device, the object-to-be-detected image tagged by an identifying box at the tagging position.

One of the exemplary embodiments is to provide an image tracking system including an image capturing device, a display device, and a processing device. The image capturing device is configured to capture an object-to-be-detected image of a to-be-detected object that the to-be-detected object includes a trackable feature and the object-to-be-detected image includes a plurality of first candidate objects, and a housing object with a first color and a pixel value of the plurality of first candidate objects is different from a pixel value of the housing object. The display device is configured to display the object-to-be-detected image. The processing device is connected with the image capturing device and the display device and configured to processing the object-to-be-detected image by using a gray-scale threshold to obtain a gray-scale image including a plurality of gray-scale candidate objects and a gray-scale housing object; converting the gray-scale image into a binary image by using a binary threshold, wherein the binary image includes a plurality of second candidate objects with the first color and the housing object with a second color; obtaining a plurality of minimum bounding rectangles of the plurality of second candidate objects of the binary image; choosing one of the plurality of minimum bounding rectangles to be a tagging position of the trackable feature; and controlling a display device to display the object-to-be-detected image tagged by an identifying box at the tagging position.

### DESCRIPTION OF THE DRAWINGS

FIG. 1 illustrates an object-to-be-detected image in accordance with one embodiment of the present disclosure.

FIG. 2 illustrates a binary image obtained from the object-to-be-detected image in FIG. 1 in accordance with one embodiment of the present disclosure.

FIG. 3 is a block diagram illustrating an image tracking system in accordance with one embodiment of the present disclosure.

FIG. 4 is a flowchart illustrating an image tracking method in accordance with one embodiment of the present disclosure.

FIG. 5 illustrates an example object-to-be-detected image in accordance with one embodiment of the present disclosure.

FIG. 6 illustrates an example gray-scale image obtained from the object-to-be-detected image in FIG. 5 in accordance with one embodiment of the present disclosure.

FIG. 7 illustrates an example binary image converted from the gray-scale image in FIG. 6 in accordance with one embodiment of the present disclosure.

FIG. 8 is a schematic diagram illustrating an identifying box tagged on the object-to-be-detected image in accordance with one embodiment of the present disclosure.

FIG. 9 illustrates another example object-to-be-detected image in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

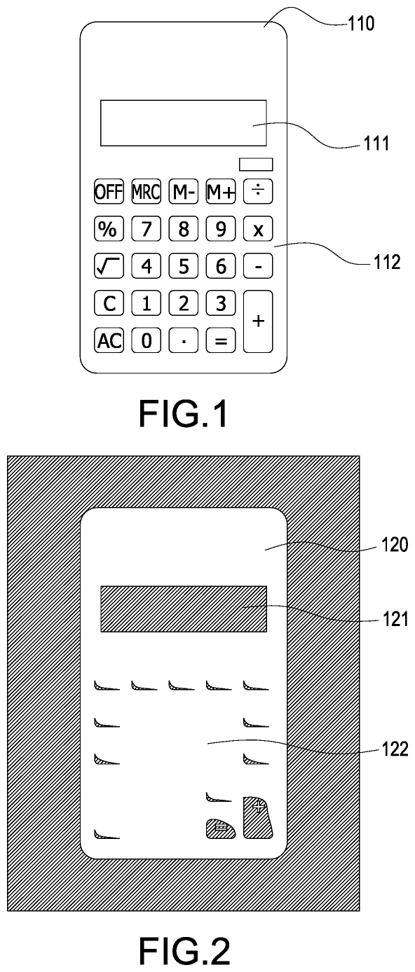

Reference is made to FIG. 1. FIG. 1 illustrates an object-to-be-detected image in accordance with one embodiment of the present disclosure. A feature of the to-be-detected object shown in FIG. 1 is a display screen of a calculator. The display screen is taken as an example of the feature of the to-be-detected object. As shown in the calculator image 110 in FIG. 1, the calculator has a display screen 111 and a white housing 112. A surrounding area near the display screen 111 has the color same as the white housing 112, such that it seems like the display screen 111 is embedded in the white housing 112 without a border. Specifically, the surrounding area of the display screen 111 adjacent to the white housing 112 seems nonobvious (e.g., the surrounding area is not a black border). It should be noted that the surrounding area of the display screen 111 is a part of the white housing 112, and the color of the surrounding area of the display screen 111 is a feature to be described in the present disclosure.

Reference is made to FIG. 2. FIG. 2 illustrates a binary image obtained from the object-to-be-detected image in FIG. 1 in accordance with one embodiment of the present disclosure. An image tracking system executes a binary processing to the calculator image 110 to obtain a binary image 120 as shown in FIG. 2. The binary image 120 corresponds to the calculator image 110 in FIG. 1. A white area of the binary image 120 is the housing 122 of the calculator, a black area of the binary image 120 is the display screen 121 and a button area (not numbered) of the calculator, and the area outside the housing 122 is a background area (not numbered).

To recognize, in the binary image 120, the feature of the to-be-detected object, the image tracking system executes a boundary detection algorithm to the binary image 120 to detect all white objects in the binary image 120. Therefore, the image tracking system obtains a minimum bounding rectangle that encloses the white object.

In one embodiment, the image tracking system computes the minimum bounding rectangle of each white object, for example, the image tracking system obtains the minimum bounding rectangle that encloses the entire calculator (e.g., the housing 122) as shown in FIG. 2. The minimum bounding rectangle is used to locate the position of the calculator, so the image tracking is achieved.

The boundary detection algorithm includes the processes of detecting the white pixels of the object and computing the minimum bounding rectangle that encloses the object. Because the display screen 121 of the binary image 120 is in black color, the image tracking system may not compute the minimum bounding rectangle of the black object. In the embodiment, the image tracking system may not obtain the minimum bounding rectangle that encloses the display screen 121. In this case, the image tracking system may not effectively track the calculator based on the feature of the display screen 121 when the boundary detection algorithm is applied to detect the white pixels to compute the minimum bounding rectangle of the object.

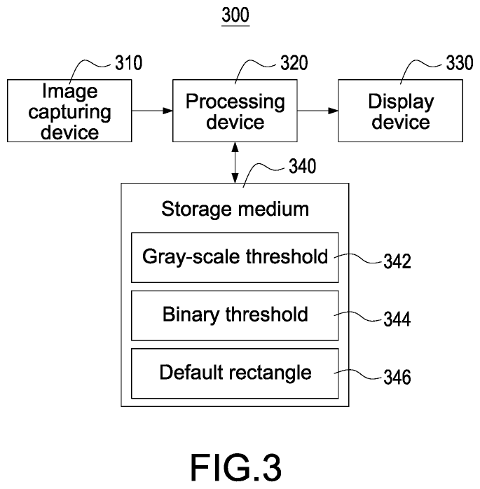

Reference is made to FIG. 3. FIG. 3 is a block diagram illustrating an image tracking system in accordance with one embodiment of the present disclosure. The image tracking system 300 in FIG. 3 includes an image capturing device 310, a processing device 320, a display device 330, and a storage medium 340. The processing device 320 is connected with the image capturing device 310, the display device 330, and the storage medium 340.

In one embodiment, image capturing device 310 is configured to capture an object-to-be-detected image of a to-be-detected object having a trackable feature. The processing device 320 executes an image recognition process to the object-to-be-detected image and tags the trackable feature of the to-be-detected object in the object-to-be-detected image. The display device 330 displays the object-to-be-detected image. The storage medium 340 stores data and programs of image processing. The data includes a gray-scale threshold 342, a binary threshold 344, and a default rectangle 346.

In one embodiment, the trackable feature is the display screen of the calculator, but the trackable feature is not limited to the display screen of the calculator in the present disclosure.

In one embodiment, the image capturing device 310 may be a camera.

In one embodiment, the processing device 320 may be but not limited to the central processing unit (CPU), the system on chip (SoC), the processors for specific applications, the audio processors, the digital signal processors (DSP), the processing chips, the controllers for specific functions, or an electronic device including any element above.

In one embodiment, the display device 330 includes a display, a projector, or any electronic device with a display function.

In one embodiment, the storage medium 340 may be but not limited to the random-access memory (RAM), the nonvolatile memory (such as the flash memory), the read-only memory (ROM), the hard disk drive (HDD), the solid-state drive (SSD), or the optical storage.

For facilitating the understanding, the disclosure takes the calculator as an example of the to-be-detected object, but the to-be-detected object is not limited to the calculator. In another embodiment, the to-be-detected object may be the tablet computer. Specifically, the present disclosure takes the calculator having the trackable feature where the surrounding area of the trackable feature (adjacent to another object (e.g., the housing)) is not obvious as an embodiment, but the present disclosure is not limited herein.

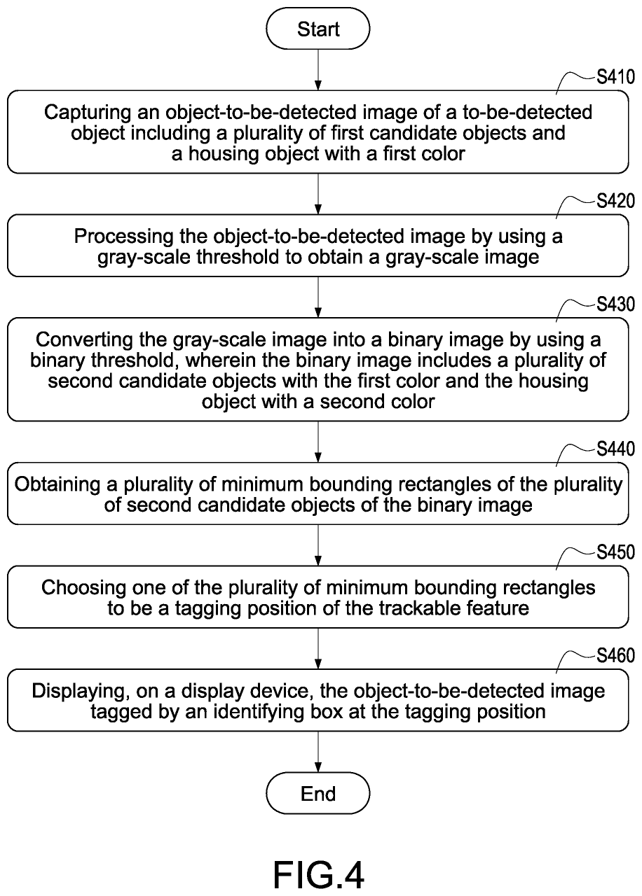

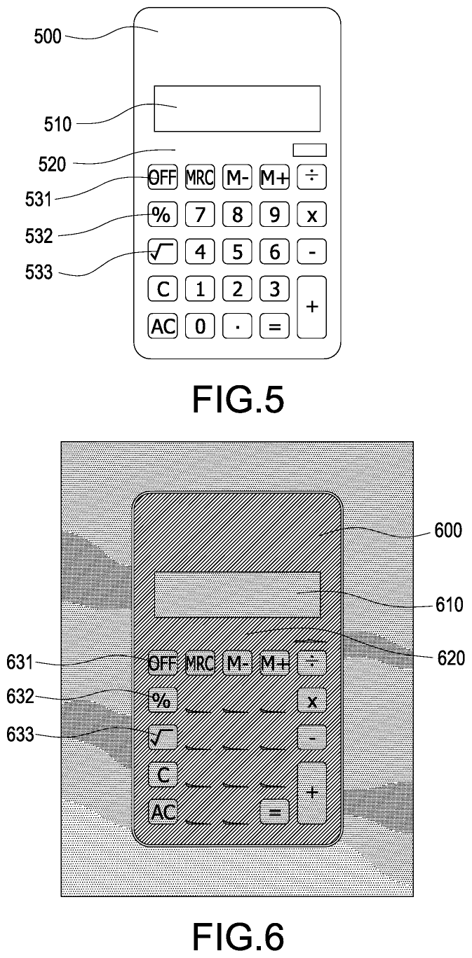

Reference is made to FIG. 4. FIG. 4 is a flowchart illustrating an image tracking method in accordance with one embodiment of the present disclosure. In one embodiment, the image tracking method in FIG. 4 is executed by the image tracking system 300 in FIG. 3. For facilitating the understanding, the detailed description of each step of the image tracking method is illustrated and incorporated with FIGS. 5 to 7 as follows.

In step S410, the object-to-be-detected image is captured by the image capturing device 310. Reference is made to FIG. 5. FIG. 5 illustrates an example object-to-be-detected image in accordance with one embodiment of the present disclosure. In one embodiment, the object-to-be-detected image 500 is a gray-scale image.

In one embodiment, the object-to-be-detected image 500 includes a housing object 520 with a first color and a plurality of first candidate objects 510, 531, 532, and 533. In one embodiment, the to-be-detected object has the trackable feature. For example, the to-be-detected object is the calculator, and the trackable feature of the to-be-detected object is the display screen of the calculator.

The object-to-be-detected image 500 in FIG. 5 is a calculator image, and the image content of the first candidate object 510 of the object-to-be-detected image 500 includes the trackable feature of the to-be-detected object. The housing object 520 may be the image area outside the display screen of the calculator image, such as the housing of the calculator. The image content of the first candidate objects 531, 532, and 533 is the button of the calculator.

In one embodiment, the first color is white color. In the embodiment, the color of the first candidate objects 510, 531, 532, and 533 is gray color, and the color of the housing object 520 is white color.

In one embodiment, a pixel value of the plurality of first candidate objects 510, 531, 532, and 533 of the object-to-be-detected images 500 is different from a pixel value of the housing object 520. For example, the housing of the calculator is in white color and the pixel value of the housing object 520 presents white color. The buttons of the calculator are in gray color, the display screen is in dark gray color, the pixel value of the first candidate objects 531, 532, and 533 presents gray color, and the pixel value of the first candidate object 510 presents dark gray color. Because the pixel values of gray color and the dark gray color are less than the pixel value of the white color, the pixel values of the first candidate objects 510, 531, 532, and 533 are less than the pixel value of the housing object 520. In another embodiment, the pixel value of the first candidate objects 510, 531, 532, and 533 is greater than the pixel value of the housing object 520 (not shown in figures).

In step S420, the object-to-be-detected image 500 is processed, by the processing device 320, by using the gray-scale threshold 342 to obtain a gray-scale image. The gray-scale image includes a plurality of gray-scale candidate objects and a gray-scale housing object. In the embodiment, because the object-to-be-detected image 500 obtained in step S410 is the gray-scale image, the object-to-be-detected image 500 is processed again in step S420 (such as by using the inverted threshold to zero computation) to obtain another gray-scale image. Therefore, the efficiency of recognizing the trackable feature in the image (i.e., another gray-scale image) and locating the trackable feature in the image is improved.

In step S420, the plurality of first candidate objects 510, 531, 532, and 533 are processed, by the processing device 320, to obtain the plurality of gray-scale candidate objects. Also, in step S420, the housing object 520 is converted, by the processing device 320, into the gray-scale housing object 620 with black color.

In one embodiment, the first candidate objects 510, 531, 532, and 533 are the gray-scale image objects.

In one embodiment, the image processing of converting the image executed in step S420 may be the inverted threshold to zero computation (THRESH_TOZERO_INV) of OPENCV, so the object-to-be-detected image 500 is converted into the gray-scale image 600. The gray-scale threshold 342 is used as the threshold value to convert the grayscale of the image from a pixel value into another, such that each pixel value of the image is converted, based on the threshold value, from a pixel value to another. Therefore, the gray-scale image (e.g., the object-to-be-detected image 500) is converted into another gray-scale image (e.g., the gray-scale image 600).

In one embodiment, the processing device 320 processes the object-to-be-detected image 500 to obtain the gray-scale image 600 by using Function (1):

$$f ( x ) = \{ \begin{matrix}x , x \leq Th 1 \\ 0 , x > Th 1\end{matrix} \qquad Function ( 1 )$$

In Function (1), x represents the pixel value of the object-to-be-detected image 500, f(x) represents the pixel value of the gray-scale image 600, and Th1 represents the gray-scale threshold. If the pixel value of the object-to-be-detected image 500 is greater than the gray-scale threshold Th1, the pixel value of the gray-scale image 600 is converted into zero. If the pixel value of the object-to-be-detected image 500 is not greater than the gray-scale threshold Th1, the pixel value of the gray-scale image is maintained as its original pixel value.

It should be noted that Function (1) is taken as an example and any function used to convert the grayscale of images may be applied in the present disclosure.

In one embodiment, processing the object-to-be-detected image 500 by the processing device 320 by using the gray-scale threshold to obtain the gray-scale image further includes adjusting a gray-scale value of the pixel (the pixel value) of the object-to-be-detected image 500, such that the gray-scale value of the pixel of the object-to-be-detected image 500 that is initially less than the gray-scale threshold is changed to be relatively greater than the gray-scale value of the pixel of the object-to-be-detected image 500 that is initially greater than the gray-scale threshold. The gray-scale threshold is applied as a base value to classify the pixel values of the object-to-be-detected image 500. In the object-to-be-detected image 500, some pixel values (a first pixel group (e.g., the plurality of first candidate objects 510, 531, 532, and 533)) are less than the gray-scale threshold, and other pixel values (a second pixel group (e.g., the housing object 520)) are greater than the gray-scale threshold. That is, initially the gray-scale value of the first pixel group of the object-to-be-detected image 500 is less than the gray-scale value of the second pixel group of the object-to-be-detected image 500. After the object-to-be-detected image 500 is processed in step S420, the gray-scale value of the first pixel group of the gray-scale image 600 (shown in FIG. 6) is greater than the gray-scale value of the second pixel group of the gray-scale image 600 (shown in FIG. 6).

Reference is made to FIG. 6. FIG. 6 illustrates an example gray-scale image obtained from the object-to-be-detected image in FIG. 5 in accordance with one embodiment of the present disclosure. The gray-scale image 600 in FIG. 6 includes gray-scale candidate objects 610, 631, 632, and 633 and gray-scale housing object 620. The gray-scale candidate object 610 corresponds to the first candidate object 510 of the object-to-be-detected image 500, the gray-scale housing object 620 corresponds to the housing object 520 of the object-to-be-detected image 500, and the gray-scale candidate objects 631, 632, and 633 respectively correspond to the first candidate objects 531, 532, and 533 of the object-to-be-detected images 500.

In one embodiment, because the gray-scale threshold Th1 used by the processing device 320 is not less than the pixel value of the plurality of first candidate objects 510, 531, 532, and 533, the pixel value of the gray-scale image 600 remains their original pixel value (i.e., the plurality of first candidate objects 510, 531, 532, and 533) after the plurality of first candidate objects 510, 531, 532, and 533 are processed by Function (1). On the other hand, because the pixel value of the plurality of first candidate objects 510, 531, 532, and 533 is less than the pixel value of the housing object 520 (e.g., white color) and the pixel value of the housing object 520 is greater than the gray-scale threshold, the processing device 320 may not only remain the trackable feature of the object-to-be-detected image 500 by using Function (1) but also accentuate the feature of the plurality of first candidate objects 510, 531, 532, and 533 to the gray-scale image 600 by converting the pixel value of the housing object 520 into black color.

In step S430, the gray-scale image 600 is converted, by the processing device 320, into the binary image by using the binary threshold 344. In one embodiment, the binary image includes a plurality of second candidate objects with the first color and the housing object with a second color.

In one embodiment, the processing device 320 converts the gray-scale image 600 into the binary image by using Function (2):

$$g ( x ) = \{ \begin{matrix}0 , x \leq Th 2 \\ 255 , x > Th 2\end{matrix} \qquad Function ( 2 )$$

In Function (2), x represents the pixel value of the gray-scale image 600, g(x) represents the pixel value of the binary image, and Th2 represents the binary threshold 344. It should be noted that the Function (2) is taken as an example, and any function converting the image into the binary image may be applied in the present disclosure.

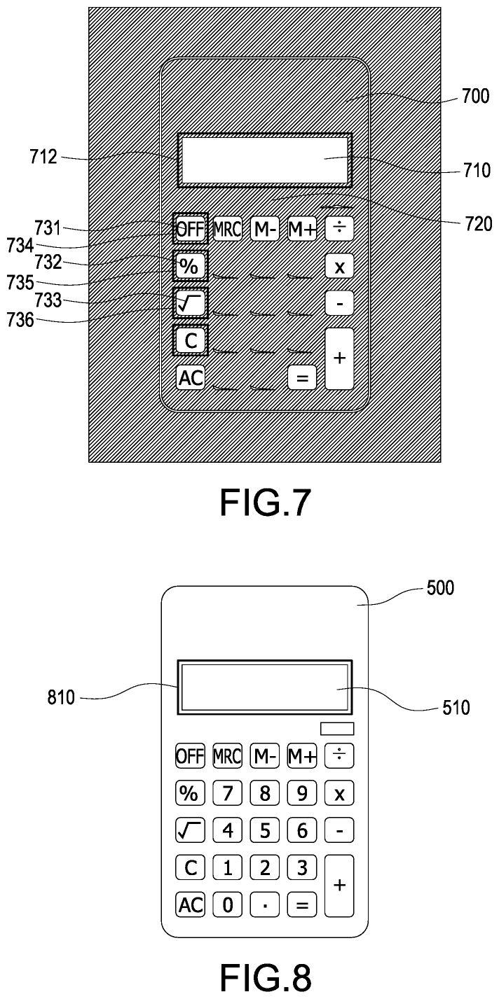

Reference is made to FIG. 7. FIG. 7 illustrates an example binary image converted from the gray-scale image in FIG. 6 in accordance with one embodiment of the present disclosure. In the embodiment, the binary image 700 in FIG. 7 is a monochromatic image that includes the plurality of second candidate objects (such as the display screen and the multiple buttons of the calculator (‘OFF’, ‘%’, ‘√’, and other buttons which are not marked)).

In one embodiment, the binary threshold Th2 used by the processing device 320 is less than the pixel value of the gray-scale candidate objects 610, 631, 632, and 633 in FIG. 6. Therefore, the processing device 320 may apply the Function (2) to convert the gray-scale candidate objects 610, 631, 632, and 633 of the gray-scale images 600 in FIG. 6 into the second candidate objects 710, 731, 732, and 733 with the first color in FIG. 7, and convert the gray-scale housing object 620 of the gray-scale image 600 in FIG. 6 into the housing object 720 with the second color in FIG. 7. In one embodiment, the first color is white color and the second color is black color.

In one embodiment, after the processing device 320 processes the object-to-be-detected image 500 to obtain the gray-scale image 600, because the pixel value of the first candidate objects 510, 531, 532, and 533 is not greater than the gray-scale threshold Th1, the pixel value of the first candidate objects 510, 531, 532, and 533 in FIG. 5 is not changed by the processing device 320. Therefore, the pixel value of the gray-scale candidate objects 610, 631, 632, and 633 in FIG. 6 is equivalent to the pixel value of the first candidate objects 510, 531, 532, and 533 in FIG. 5. In the embodiment, the binary threshold Th2 is chosen to be less than the pixel value of the first candidate objects 510, 531, 532, and 533 so as to improve the effectiveness of the binary processing.

In step S440, the plurality of minimum bounding rectangles of the plurality of second candidate objects 710, 731, 732, and 733 is obtained from the binary image 700 by the processing device 320. In one embodiment, the minimum bounding rectangle is a minimum rectangle that encloses the second candidate object. As shown in FIG. 7, the second candidate object 710 has a minimum bounding rectangle 712, the second candidate object 731 has a minimum bounding rectangle 734, the second candidate object 732 has a minimum bounding rectangle 735, and the second candidate object 733 has a minimum bounding rectangle 736.

In one embodiment, the term “object” in the present disclosure may be the image block that is formed by pixels having the same or similar pixel value. The processing device 320 executes the boundary detection algorithm to the binary image 700 and computes a plurality of object contours of the plurality of second candidate objects of the binary image 700.

As described above, the present disclosure is applied to the to-be-detected object (such as the calculator in FIG. 5) that has the housing (i.e., the high pixel value) with white color (the first color), and the surrounding area of the trackable feature that is adjacent to the white housing may be not obvious (e.g., the color or the pixel value of the trackable feature and the color or the pixel value of the housing are the same or similar). When the object-to-be-detected image 500 is converted into the binary image 700, because the pixel value of the trackable feature is less than the pixel value of the housing with the white color, the area of the trackable feature is converted into black (the second color) object. In this case, when the processing device 320 executes the boundary detection algorithm that is used to detect white object contours, the processing device 320 may not find the object contour corresponding to the trackable feature of the binary image 700.

In the present disclosure, the object-to-be-detected image 500 is converted into the gray-scale image 600 by using the default gray-scale threshold 342 to decrease the pixel value of the housing image, with the white color, of the to-be-detected object, such that the pixel value of the trackable feature is changed, in the gray-scale image 600, to be greater than the pixel value of the housing with the white color in the gray-scale image 600. Therefore, when the processing device 320 converts the gray-scale image 600 into the binary image 700, the area corresponding to the trackable feature is converted into the second candidate object with the white color in the binary image 700, and the processing device 320 may execute the boundary detection algorithm that is used to detect white object contours to the binary image 700 and the object contour corresponding to the trackable feature may be found from the second candidate object of the binary image 700.

In one embodiment, the processing device 320 obtains the minimum bounding rectangle corresponding to each object according to the rectangle that encloses the object contour. For facilitating the understanding, the white color is taken as an example of the first color of the pixel block.

The processing device 320 may obtain the minimum bounding rectangle of each second candidate object with the white color from the contour of the white second candidate object. The minimum bounding rectangle is the minimum rectangle that encloses the white second candidate object. For example, the white second candidate object 710 in FIG. 7 is the display screen of the calculator, and the white second candidate objects 731, 732, and 733 in FIG. 7 are the buttons of the calculator.

The processing device 320 respectively computes the object contours of the white second candidate objects 710, 731, 732, and 733 by using the boundary detection algorithm, so the processing device 320 may compute the minimum bounding rectangle that encloses each object contour. As shown in FIG. 7, the white second candidate object 710 has the minimum bounding rectangle 712, the white second candidate object 731 has the minimum bounding rectangle 734, the white second candidate object 732 has the minimum bounding rectangle 735, and the white second candidate object 733 has the minimum bounding rectangle 736. It should be noted that the monochromatic image (e.g., the binary image) in FIG. 7 includes multiple buttons. To simplify the description, the button images are represented by the white second candidate objects 731, 732, and 733.

In step S450, one of the pluralities of minimum bounding rectangles is used as the tagging position of the trackable feature by the processing device 320.

In one embodiment, the processing device 320 sets a default rectangle 346 in advance according to a shape and a size of the trackable feature in the image and stores the default rectangle 346 in the storage medium 340. In one embodiment, the default rectangle 346 is the trackable feature corresponding to the display screen in FIG. 5. The processing device 320 respectively compares the minimum bounding rectangles 712, 734, 735, and 736 in FIG. 7 with the default rectangle 346 in step S450 to find the rectangle that matches the default rectangle 346 the most. In the embodiment, the default rectangle 346 is corresponding to the display screen, so that the rectangle that matches the default rectangle 346 the most is the minimum bounding rectangle 712 that encloses the object contour of the second candidate object 710. Therefore, the processing device 320 may set the position of the minimum bounding rectangle 712 to be the tagging position that tags the trackable feature.

In step S460, the display device 330 displays the object-to-be-detected image tagged with an identifying box at the tagging position. In one embodiment, the processing device 320 generates the identifying box and displays the identifying box at the image position of the minimum bounding rectangle 712. The position at which the identifying box is tagged is the position of the trackable feature. The identifying box has its design style and color, and the processing device 320 generates the identifying box according to the preset design style and color.

Reference is made to FIG. 8. FIG. 8 is a schematic diagram illustrating an identifying box tagged on the object-to-be-detected image in accordance with one embodiment of the present disclosure. As described above, the tagging position obtained by the processing device 320 corresponds to the position of the trackable feature of the object-to-be-detected image 500. After the processing device 320 generates the identifying box 810, the display device 330 displays the object-to-be-detected image 500 with the identifying box 810 overlaying on the first candidate object 510. In other words, the first candidate object 510 tagged by the identifying box 810 is the trackable feature of the calculator. In one embodiment, the identifying box 810 overlays along the edge of the first candidate object 510.

The present disclosure as described in steps S410 to S460 in FIG. 4 discloses recognizing and tracking the trackable feature of the object-to-be-detected image 500 and generating the identifying box 810 corresponding to the position of the trackable feature. Therefore, when the to-be-detected object moves or rotates, the processing device 320 may still recognize that the position of the trackable feature is changed, and the identifying box 810 that overlays on the object-to-be-detected image 500 is moved or rotated correspondingly, so the steadiness of the procedure of tracking the object-to-be-detected image 500 is ensured.

The description above discloses that after the object-to-be-detected image 500 is converted into the gray-scale image 600 and the binary image 700, the image feature of the image of the to-be-detected object is correctly tagged by recognizing the trackable feature (such as the display screen of the calculator) of the object-to-be-detected image 500.

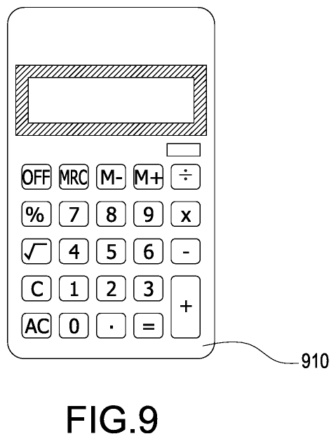

Reference is made to FIG. 9. FIG. 9 illustrates another example object-to-be-detected image in accordance with one embodiment of the present disclosure. Compared with the calculator image 110 in FIG. 1, a black border surrounds the display screen of the calculator image 910 in FIG. 9. The trackable feature of this type of the calculator image 910 is the black border. Therefore, the image processing method applied to the calculator image 910 (hereinafter referred to as “the related image processing method”) includes executing the binary processing to the calculator image 910 to obtain the binary image that includes a white border, and the white border corresponds to the black border of the calculator image 910. The related image processing method further includes recognizing all the white image objects of the binary image, recognizing the trackable feature of the calculator image 910, and locating the position of the trackable feature of the calculator image 910.

Based on the program architecture of the related image processing method that is used to detect the white border of the object, the present disclosure provides the image tracking method that processes the object-to-be-detected image 500 in FIG. 5 by using the gray-scale processing to obtain the gray-scale image 600 in FIG. 6, converts the housing object 520 with the white color of the object-to-be-detected image 500 into the gray-scale housing object 620 with the black color (or near black color), and remains the color of the gray-scale candidate object 610. The image tracking method further processes the gray-scale image 600 to obtain the binary image 700, so the second candidate object 710 of the binary image 700 is the white object (compared with FIG. 2, the pixel value of the display screen 121 of the binary image 120 is the black color), and there is an obvious different color between the second candidate object 710 (the white color) and the housing object 720 (the black color). By applying the related image processing method to the binary image 700, as described above, after all the white image objects are recognized in the binary image 700, the trackable feature of the binary image 700 is recognized (such as the second candidate object 710), and the position of the trackable feature is located in the calculator image 500. Therefore, the image tracking method may be applied to different types of the object-to-be-detected image without changing the program architecture, so the program architecture remains the consistency and the expenses of the program development is controlled.

In another embodiment, the first color is black color and the second color is white color, and the pixel value (the gray-scale value) and the thresholds mentioned above may be set or reversed to implement the image tracking system and method of the present disclosure.

To improve the efficiency of the gray scale procedure, before the image feature of the to-be-detected object is detected and tagged by using the identifying box, the user may find the gray-scale threshold that is suitable for each type of product according to the image feature of the type of products. Accordingly, when the image tracking system converts the image of the type of products into the gray-scale image 600, the gray-scale image 600 is applied to the image processing in order to produce the same effect (e.g., the effect of detecting the object contour) as described above.

To simplify the description, the term “model object” indicates the product that its corresponding gray-scale threshold is going to be found. In one embodiment, the model object is the same product of the to-be-detected object, such as the product having the same model, appearance, and operating function. The present disclosure computes the image feature of the model object and records the suitable gray-scale threshold, so the gray-scale threshold may be applied to all the reproduction objects that are the same as the model objects (such as the to-be-detected object). The model object takes the calculator as one example in the present disclosure, and it is not limited herein.

Reference back to FIG. 3, in one embodiment, the image capturing device 310 is configured to capture a model object image of the model object. The processing device 320 computes a modeling parameter (such as the gray-scale threshold 342, the binary threshold 344, and the default rectangle 346) based on the model object image. The model object includes the trackable feature (such as the display screen of the calculator), but the trackable feature is not limited to the display screen in the present disclosure. The processing device 320 sets the default rectangle 346 according to the shape and the size of the trackable feature of the image.

In one embodiment, before the modeling parameter is found, the image capturing device 310 obtains the model object image. The processing device 320 computes the model object image by using the gray-scale processing with different values, in order to find the gray-scale threshold that accentuates the trackable feature the most, and then the gray-scale threshold 342 is stored and used as the modeling parameter of the model object. When the image tracking system executes the image recognition and tracking, the processing device 320 applies the gray-scale threshold 342 of the type of the to-be-detected object to process the object-to-be-detected image, in order to generate the corresponding gray-scale image 600.

As described above, the image tracking system and the image tracking method convert the image into the gray-scale image and convert the gray-scale image into the binary image, such that the position of the trackable feature in the image is easy to be computed, and the accuracy of image tracking is improved. Furthermore, the present disclosure analyzes the position of the trackable feature instead of the position of the entire to-be-detected object, so the problem that the position of the object in the two-dimension image cannot be indicated correctly when multiple to-be-detected objects (partially) overlap with each other in the three-dimensional space is solved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image tracking method, comprising:
capturing, by an image capturing device, an object-to-be-detected image of a to-be-detected object, wherein the to-be-detected object comprises a trackable feature and the object-to-be-detected image comprises a plurality of first candidate objects and a housing object with a first color, and a pixel value of the plurality of first candidate objects is different from a pixel value of the housing object;
processing the object-to-be-detected image by using a gray-scale threshold to obtain a gray-scale image comprising a plurality of gray-scale candidate objects and a gray-scale housing object;
converting the gray-scale image into a binary image by using a binary threshold, wherein the binary image comprises a plurality of second candidate objects with the first color and the housing object with a second color;
obtaining a plurality of minimum bounding rectangles of the plurality of second candidate objects of the binary image;
choosing one of the pluralities of minimum bounding rectangles to be a tagging position of the trackable feature; and
displaying, on a display device, the object-to-be-detected image tagged by an identifying box at the tagging position.

2. The image tracking method of claim 1, wherein obtaining the plurality of minimum bounding rectangles of the plurality of second candidate objects of the binary image further comprises:
computing a plurality of object contours of the plurality of second candidate objects of the binary image; and
obtaining each of the plurality of the minimum bounding rectangles of each of the plurality of object contours according to a rectangle enclosing each of the plurality of object contours.

3. The image tracking method of claim 1, wherein choosing one of the pluralities of minimum bounding rectangles to be the tagging position of the trackable feature comprises:
choosing one of the pluralities of minimum bounding rectangles matching a default rectangle to be the minimum bounding rectangle matching the default rectangle; and
setting a position of the minimum bounding rectangle being chosen to be the tagging position.

4. The image tracking method of claim 3, wherein before choosing one of the pluralities of minimum bounding rectangles matching the default rectangle comprises:
setting the default rectangle according to a shape and a size of the trackable feature.

5. The image tracking method of claim 1, wherein processing the object-to-be-detected image by using the gray-scale threshold to obtain the gray-scale image comprises adjusting a gray-scale value of the pixel of the object-to-be-detected image, such that the gray-scale value of the pixel of the object-to-be-detected image that is less than the gray-scale threshold is changed to be relatively greater than the gray-scale value of the pixel of the object-to-be-detected image that is greater than the gray-scale threshold.

6. The image tracking method of claim 1, wherein processing the object-to-be-detected image by using the gray-scale threshold to obtain the gray-scale image comprises converting the plurality of first candidate objects into the plurality of gray-scale candidate objects and converting the housing object with the first color into the gray-scale housing object with the second color.

7. The image tracking method of claim 1, wherein converting the gray-scale image into the binary image by using the binary threshold comprises converting the plurality of gray-scale candidate objects into the plurality of second candidate objects with the first color and converting the gray-scale housing object into the housing object with the second color.

8. The image tracking method of claim 1, wherein the first color is white color and the second color is black color.

9. The image tracking method of claim 1, wherein processing the object-to-be-detected image by using the gray-scale threshold to obtain the gray-scale image comprises executing an inverted threshold to zero computation to the object-to-be-detected image.

10. The image tracking method of claim 1, wherein the binary threshold is less than a pixel value of the plurality of gray-scale candidate objects.

11. An image tracking system, comprising:
an image capturing device, configured to capture an object-to-be-detected image of a to-be-detected object, wherein the to-be-detected object comprises a trackable feature and the object-to-be-detected image comprises a plurality of first candidate objects and a housing object with a first color, and a pixel value of the plurality of first candidate objects is different from a pixel value of the housing object;
a display device, configured to display the object-to-be-detected image; and
a processing device, connected with the image capturing device and the display device and configured to:
processing the object-to-be-detected image by using a gray-scale threshold to obtain a gray-scale image comprising a plurality of gray-scale candidate objects and a gray-scale housing object;
converting the gray-scale image into a binary image by using a binary threshold, wherein the binary image comprises a plurality of second candidate objects with the first color and the housing object with a second color;
obtaining a plurality of minimum bounding rectangles of the plurality of second candidate objects of the binary image;
choosing one of the pluralities of minimum bounding rectangles to be a tagging position of the trackable feature; and
controlling a display device to display the object-to-be-detected image tagged by an identifying box at the tagging position.

12. The image tracking system of claim 11, wherein the processing device is configured to compute a plurality of object contours of the plurality of second candidate objects of the binary image and obtain each of the plurality of the minimum bounding rectangles of each of the plurality of object contours according to a rectangle enclosing each of the plurality of object contours.

13. The image tracking system of claim 11, further comprising a storage medium connected with the processing device and configured to store the gray-scale threshold, wherein the processing device is configured to choose one of the pluralities of minimum bounding rectangles matching a default rectangle and set a position of the minimum bounding rectangle being chosen to be the tagging position.

14. The image tracking system of claim 13, wherein the processing device is configured to set the default rectangle according to a shape and a size of the trackable feature.

15. The image tracking system of claim 11, wherein the processing device is configured to adjust a gray-scale value of the pixel of the object-to-be-detected image, such that the gray-scale value of the pixel of the object-to-be-detected image that is less than the gray-scale threshold is changed to be relatively greater than the gray-scale value of the pixel of the object-to-be-detected image that is greater than the gray-scale threshold.

16. The image tracking system of claim 11, wherein the processing device is configured to process the object-to-be-detected image by using the gray-scale threshold, such that the plurality of first candidate objects is converted into the plurality of gray-scale candidate objects and the housing object with the first color is converted into the gray-scale housing object with the second color.

17. The image tracking system of claim 11, wherein the processing device is configured to convert the gray-scale image into the binary image by using the binary threshold, such that the plurality of gray-scale candidate objects is converted into the plurality of second candidate objects with the first color and the gray-scale housing object is converted into the housing object with the second color

18. The image tracking system of claim 11, wherein the binary threshold is less than a pixel value of the plurality of gray-scale candidate objects.

19. The image tracking system of claim 11, wherein the first color is white color, and the second color is black color.

20. The image tracking system of claim 11, wherein the processing device is configured to execute an inverted threshold to zero computation to the object-to-be-detected image to obtain the gray-scale image.
